(19) United States
(12) Patent Application Publication
(10) Pub. No.: US 2017/0362716 A1
(43) Pub. Date: Dec. 21, 2017

(54) METHOD FOR FABRICATING ELECTRODE FOR SPLITTING WATER WITH LIGHT AND ELECTRODE FOR WATER SPLITTING PROVIDED BY THE METHOD

(71) Applicant: Panasonic Corporation, Osaka (JP)

(72) Inventors: TAKAHIRO KURABUCHI, Osaka (JP); MISA YOROZUYA, Osaka (JP); KAZUHITO HATO, Osaka (JP); RYU ABE, Nara (JP); MASANOBU HIGASHI, Kyoto (JP); TAKAHIDE OTSUBO, Kyoto (JP)

(21) Appl. No.: 15/615,427

(22) Filed: Jun. 6, 2017

(30) Foreign Application Priority Data
Jun. 20, 2016 (JP) 2016-121579

(51) Int. Cl. C25B 1/00; C25B 1/10; C25D 11/00; H01M 8/0656

(52) U.S. Cl. CPC C25B 1/003; H01M 8/0656; C25B 1/10; C25D 11/00

(57) ABSTRACT

The present invention provides a method for fabricating an electrode comprising a co-catalyst layer for splitting water with light. The method comprises steps of (a) forming a catalyst layer containing at least one selected from the group consisting of a niobium-containing oxynitride and a niobium-containing nitride on an electrically conductive principal surface of a substrate; (b) forming a transition metal oxide layer on the catalyst layer in an inert gas atmosphere containing oxidized gas impurities to provide a stacking structure comprising the substrate, the catalyst layer, and the transition metal oxide layer; (c) immersing the stacking structure in an electrolyte aqueous solution; and (d) applying a positive electric potential to the stacking structure in the electrolyte aqueous solution to convert the transition metal oxide layer into the co-catalyst layer. The present invention provides an electrode for water splitting having high water-splitting efficiency.

### BACKGROUND

### 1. Technical Field

The present invention relates to a method for fabricating an electrode for splitting water with light and an electrode for water splitting provided by the method.

### 2. Description of the Related Art

Patent Literature 1 discloses a photoelectrode for use in the decomposition of water, which has a good onset potential. The electrode for use in the decomposition of water according to the disclosure of Patent Literature 1 is equipped with: a support body; a photocatalyst layer which is arranged on the support body, can absorb visible light, and comprises an optical semiconductor having at least one metal element selected from the group consisting of Group 4A elements, Group 5A elements, Group 6A elements, Group 1B elements, Group 2B elements, Group 3B elements, and Group 4B elements on the periodic table; and coating layer which is arranged on the photocatalyst layer, is formed employing an atomic layer deposition method, and contains a metal oxide semiconductor. In the photoelectrode, the coating layer has a thickness of 3 to 40 nm.

### CITATION LIST

### Patent Literature

Patent Literature 1: WO 2015/151775
Patent Literature 2: United States Patent Application Publication No. 2010/0133111A1

### Non-Patent Literature

Non-Patent Literature 1: Matthew W. Kanan et al., “In Situ Formation of an Oxygen-Evolving Catalyst in Neutral Water Containing Phosphate and Co²⁺”, Science, Vol. 321, 1072-1075 (22 Aug. 2008)

Non-Patent Literature 2: Takehiro Mineo et al., “Investigation of Cobalt-Phosphate Cocatalyst on a Photoelectrode by Electrochemical XAFS”, Photo Factory Activity Report 2013 Vol. 31, (2014) B, BL-12C, 9A/2012G752

Non-Patent Literature 3: Akira Yamakata et al., “Electron- and hole-transfer to the cocatalysts on photocatalysts”, The 8^{th} Annual Meeting of Japan Society for Molecular Science, 2B15, 2014

Non-Patent Literature 4: Donghyeon Kang et al. “Electrochemical Synthesis of Photoelectrodes and Catalysts for Use in Solar Water Splitting”, Chemical Reviews, 2015. Vol. 115, pp. 12839-12887

Non-Patent Literature 5: N. S. McIntyre et al., X-Ray Photoelectron Studies on Some Oxides and Hydroxides of Cobalt, Nickel, and Copper, ANALYTICAL CHEMISTRY, VOL. 47, NO. 13, November 1975, pp. 2208-2213

### SUMMARY

The present invention provides a method for fabricating an electrode comprising a co-catalyst layer for splitting water with light, the method comprising:

(a) forming a catalyst layer containing at least one selected from the group consisting of a niobium-containing oxynitride and a niobium-containing nitride on an electrically conductive principal surface of a substrate;

(b) forming a transition metal oxide layer on the catalyst layer in an inert gas atmosphere containing oxidized gas impurities to provide a stacking structure comprising the substrate, the catalyst layer, and the transition metal oxide layer;

(c) immersing the stacking structure in an electrolyte aqueous solution; and

(d) applying a positive electric potential to the stacking structure in the electrolyte aqueous solution to convert the transition metal oxide layer into the co-catalyst layer.

The present invention provides an electrode for water splitting having high water-splitting efficiency.

### BRIEF DESCRIPTION OF THE DRAWINGS

FIG. 1A shows a cross-sectional view of one step included in a method for fabricating an electrode for water splitting according to an embodiment.

FIG. 1B shows a cross-sectional view of one step included in the method for fabricating the electrode for water splitting according to the embodiment, subsequent to the step shown in FIG. 1A.

FIG. 1C shows a cross-sectional view of one step included in the method for fabricating the electrode for water splitting according to the embodiment, subsequent to the step shown in FIG. 1B.

FIG. 1D shows a cross-sectional view of one step included in the method for fabricating the electrode for water splitting according to the embodiment, subsequent to the step shown in FIG. 1C. FIG. 1D is also a cross-sectional view of the electrode for water splitting according to the embodiment.

FIG. 2 is a schematic view of a hydrogen generation device according to the embodiment.

FIG. 3 is a scanning transmission electron microscope (hereinafter, referred to as “STEM”) image of a surface of a catalyst layer 2 formed of NbON in the inventive example 1. In FIG. 3, an element composition analysis result based on the STEM image is also shown.

FIG. 4A shows an HAXPES analysis result of a transition metal oxide layer 3 formed of a Co oxide upon the completion of the step (b) in the inventive example 1.

FIG. 4B shows an HAXPES analysis result of a catalyst layer 2 formed of a niobium compound upon the completion of the step (b) in the inventive example 1.

FIG. 4C shows an HAXPES analysis result of the transition metal oxide layer 3 formed of the Co oxide upon the completion of the step (d) in the inventive example 1.

FIG. 4D shows an HAXPES analysis result of the catalyst layer 2 formed of the niobium compound upon the completion of the step (d) in the inventive example 1.

FIG. 4E shows an HAXPES analysis result of a transition metal layer formed of Co upon the completion of the step (b) in the comparative example 1.

FIG. 4F shows an HAXPES analysis result of the catalyst layer 2 formed of the niobium compound upon the completion of the step (b) in the comparative example 1.

FIG. 4G shows an HAXPES analysis result of the transition metal layer formed of Co upon the completion of the step (d) in the comparative example 1.

FIG. 4H shows an HAXPES analysis result of the catalyst layer 2 formed of the niobium compound upon the completion of the step (d) in the comparative example 1.

FIG. 5 is a STEM image of a substrate 1 comprising the transition metal oxide layer 3.

FIG. 6 is a graph showing a relation between a current density of a photocurrent of an electrode 100 and a time in the inventive example 1, the comparative example 1, and the comparative example 2.

### DETAILED DESCRIPTION OF THE EMBODIMENT

Hereinafter, an embodiment of the present invention will be described with reference to the drawings.

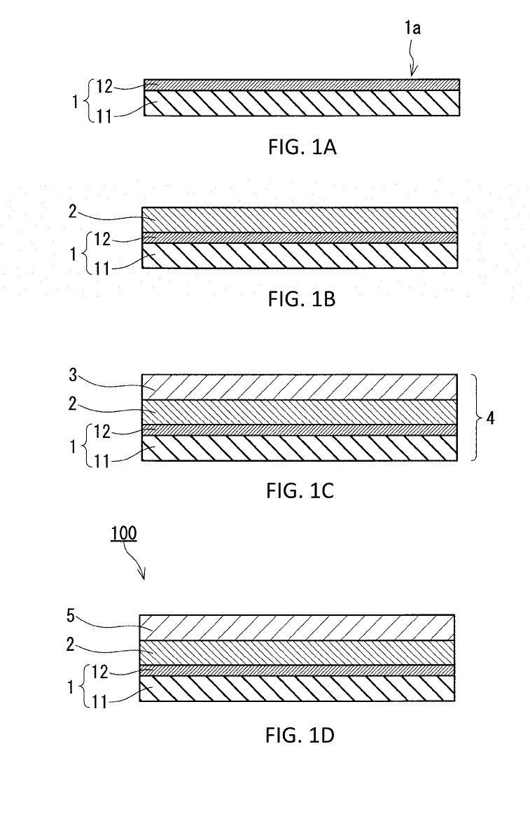

FIG. 1A-FIG. 1D show cross-sectional views of steps included in a method for fabricating an electrode for water splitting according to the embodiment.

The method for fabricating an electrode for water splitting according to the embodiment is a method for fabricating an electrode comprising a co-catalyst layer for splitting water with light. The method comprises the following steps:

Step (a): forming a catalyst layer 2 containing at least one selected from the group consisting of a niobium-containing oxynitride and a niobium-containing nitride on a principal surface of a substrate 1; the principal surface being electrically conductive;

Step (b): forming a transition metal oxide layer 3 on the catalyst layer in an inert gas atmosphere containing oxidized gas impurities to provide a stacking structure 4 comprising the substrate, the catalyst layer, and the transition metal oxide layer; the transition metal oxide layer containing a transition metal oxide;

Step (c): immersing the stacking structure in an electrolyte aqueous solution; and

Step (d): applying a positive electric potential to the stacking structure immersed in the electrolyte aqueous solution to convert the transition metal oxide layer into the co-catalyst layer.

(Step (a))

First, a substrate 1 is prepared as shown in FIG. 1A. A principal surface 1a of the substrate 1 is electrically conductive. In particular, the substrate 1 may comprise an insulation substrate 11 and a conductive film 12 which is stacked on the insulation substrate 11. It is desirable that the insulation substrate 11 has corrosion resistance against an aqueous solution containing an electrolyte. An example of a material of the insulation substrate 11 is glass, resin, quartz or sapphire. An example of a material of the conductive film 12 is a metal or a transparent conductive oxide.

Then, as shown in FIG. 1B, a catalyst layer 2 is formed on the principal surface 1a. The catalyst layer 2 may be formed on the whole area of or on a part of the principal surface 1a. The catalyst layer 2 contains at least one semiconductor photocatalyst selected from the group consisting of a niobium-containing oxynitride and a niobium-containing nitride. As one example, the catalyst layer 2 is composed of at least one semiconductor photocatalyst selected from the group consisting of a niobium-containing oxynitride and a niobium-containing nitride. An example of a material of the semiconductor photocatalyst is NbON, Nb₃N₅, CaNbO₂N, SrNbO₂N or BaNbO₂N. An example of the desirable semiconductor photocatalyst is NbON or Nb₃N₅. In other words, the desirable semiconductor photocatalyst is a niobium oxynitride or a niobium nitride. A compound represented by the chemical formula NbON or Nb₃N₅ absorbs light having a wavelength in a visible light range. Furthermore, the compound represented by the chemical formula NbON or Nb₃N₅ has a photocatalyst band structure suitable for water splitting. Therefore, water is split on the surface of such a semiconductor photocatalyst, using sunlight as a light source.

The semiconductor photocatalyst is an n-type semiconductor. For this reason, oxygen is generated on the surface of the electrode for water splitting. In other words, water is oxidized on the surface of the electrode for water splitting.

The catalyst layer 2 may be formed, for example, by a sputtering method, a method for applying and adhering powders, a vapor deposition method or a liquid-phase coating method. A niobium-containing compound precursor layer may be formed on the principal surface 1a, and then, the niobium-containing compound precursor layer may be heated in a nitrogen compound gas atmosphere to azotize the niobium-containing compound precursor layer. In this way, the niobium-containing compound precursor layer is converted into a niobium-containing nitride layer or niobium-containing oxynitride layer.

The thickness of the catalyst layer 2 is not limited. As one example, the catalyst layer 2 has a thickness of not less than 10 nanometers and not more than 1,000 nanometers.

(Step (b))

The step (b) is conducted after the step (a). In the step (b), as shown in FIG. 10, a transition metal oxide layer 3 is formed on the catalyst layer 2. In this way, a stacking structure 4 comprising the substrate 1, the catalyst layer 2 and the transition metal oxide layer 3 is formed. The transition metal oxide layer 3 is formed of a transition metal oxide. As one example, the transition metal oxide layer 3 is composed of a transition metal oxide. The term “transition metal” used in the present specification means an element in Group 3 to Group 12 in the periodic table. The term “transition metal” includes both of Group 3 elements and Group 12 elements. It is desirable that the transition metal oxide contains at least one selected from the group consisting of Mn, Fe, Co and Ni. More preferably, the transition metal oxide is an oxide of divalent cobalt.

The transition metal oxide layer 3 is formed in an inert gas atmosphere containing oxidized gas impurities. In other words, the inert gas atmosphere contains at least one oxidized gas as impurities. An example of the oxidized gas is oxygen molecules, ozone molecules or water molecules. An example of the inert gas is an argon gas. A commercially available inert gas (e.g., an argon gas) contains the oxidized gas as impurities. As just described, the inert gas used in the step (b) contains a very small amount of the oxidized gas. It is desirable that the oxidized gas has a partial pressure of not more than 10⁰ Pa. More preferably, the oxidized gas has a partial pressure of not less than 10⁻⁵ Pa. Desirably, the inert gas has a partial pressure of not less than 10⁻¹ Pa and not more than 10² Pa.

For example, the transition metal oxide layer 3 may be formed by a vapor deposition method. Specifically, the transition metal oxide layer 3 may be formed by a sputtering method, a plasma deposition method, a molecular beam epitaxy method, an ion plating method or a chemical vapor deposition method. It is desirable that a target used in these methods is a transition metal. For example, when the transition metal oxide layer 3 is formed of a cobalt oxide, the target used in these methods may be formed of cobalt.

Since the transition metal oxide layer 3 is formed of a transition metal in the inert gas atmosphere containing the oxidized gas impurities, the transition metal oxide layer 3 is formed of a transition metal oxide. Since a transition metal oxide is insoluble in water, the transition metal oxide layer 3 is prevented from being dissolved in the electrolyte aqueous solution in the step (c) and the step (d) which will be described later. As one example, the transition metal oxide layer 3 contains CoO.

The transition metal oxide layer 3 does not have to completely cover the whole surface of the catalyst layer 2. It is desirable that the transition metal oxide layer 3 covers 90% or more, more desirably, 99% more of the whole surface of the catalyst layer 2. The transition metal oxide layer 3 may cover the whole surface of the catalyst layer 2. Even if the transition metal oxide layer 3 covers the whole surface of the catalyst layer 2, a pinhole may exist in the transition metal oxide layer 3. Such a pinhole may be generated unintentionally due to a fabrication problem of the transition metal oxide layer 3.

As one example, the transition metal oxide layer 3 has a thickness of not less than 5 nanometers and not more than 50 nanometers.

(Step (c))

In the step (c), the stacking structure 4 is immersed in an electrolyte aqueous solution. The electrolyte aqueous solution will be described in the step (d) which will be described later.

(Step (d))

In the step (d), a positive electric potential is applied to the stacking structure 4 in the electrolyte aqueous solution. In this way, the transition metal oxide contained in the transition metal oxide layer 3 is converted into a co-catalyst. In other words, the transition metal oxide layer 3 is converted into a co-catalyst layer 5, as shown in FIG. 1D. In this way, the electrode 100 according to the embodiment is provided.

An example of the electrolyte aqueous solution is an aqueous solution containing phosphate type ions. Desirably, the electrolyte aqueous solution is a mixture buffer solution of sodium dihydrogen phosphate represented by the chemical formula NaH₂PO₄ and disodium hydrogen phosphate represented by the chemical formula Na₂HPO₄. It is desirable that the electrolyte aqueous solution has a pH of not less than 6 and not more than 8.

Hereinafter, a method for applying a positive electric potential to the stacking structure 4 immersed in the electrolyte aqueous solution will be described. A counter electrode is immersed in the electrolyte aqueous solution. The stacking structure 4 and the counter electrode are electrically connected to a power supply. A reference electrode may be also immersed in the electrolyte aqueous solution and electrically connected to the power supply. An example of the power supply is a potentiostat or a direct current stabilized power supply. Using the power supply, a positive electric potential is applied to the stacking structure 4 in the electrolyte aqueous solution. In this way, the transition metal oxide contained in the transition metal oxide layer 3 is converted into the co-catalyst.

The co-catalyst used in the present embodiment promotes a water-splitting reaction.

Examples of the co-catalyst used in the present embodiment are listed below.
(i) Cobalt oxide on which phosphate type ions are coordinated See Patent Literature 2, Non-Patent Literature 1 and Non-Patent Literature 2.
(ii) Transition metal oxide such as IrO₂, CoOₓ, CoO(OH), RuO₂, or MnOₓ See Non-Patent Literature 3 and Non-Patent Literature 4.

As one example, if the transition metal oxide layer 3 contains a Co oxide containing divalent cobalt ions (e.g., CoO) and the electrolyte aqueous solution is a phosphate buffer solution having a pH of not less than 6 and not more than 8, the applied positive electric potential is not less than 0 volts and not more than +1.6 volts. At least a part of the positive electric potential applied to the stacking structure 4 may be a photovoltaic power of the catalyst layer 2 generated by irradiating the catalyst layer 2 with light using a light source. In this case, the light emitted by the light source is absorbed by the catalyst layer 2. In other words, the light emitted by the light source has a wavelength included in a range of a wavelength of light which the catalyst layer 2 absorbs.

The catalyst layer 2 contains at least one selected from the group consisting of a niobium-containing oxynitride and a niobium-containing nitride. The niobium-containing oxynitride or niobium-containing nitride is capable of absorbing ultraviolet light and visible light. Therefore, it is desirable that the light source emits ultraviolet light and visible light. An example of such a light source is a mercury lamp, a xenon lamp, an LED or a solar simulator.

After a predetermined time elapses, the application of the positive electric potential is completed. Then, the stacking structure 4 is drawn from the electrolyte aqueous solution. In this way, the electrode 100 according to the embodiment is provided.

As shown in FIG. 1D, the electrode 100 according to the embodiment is fabricated by the above-mentioned fabrication method. The electrode 100 according to the embodiment comprises a substrate having an electrically conducive principal surface, a catalyst layer formed on the electrically conducive principal surface and containing at least one selected from the group consisting of a niobium-containing oxynitride and a niobium-containing nitride, and a co-catalyst layer covering the catalyst layer. The co-catalyst layer contains a co-catalyst for promoting a water-splitting reaction caused by light. The co-catalyst contains a transition metal oxide. The transition metal oxide contains trivalent or tetravalent transition metal ions.

Since the transition metal oxide layer 3 is formed in the inert gas atmosphere containing the oxidized gas as impurities in the step (b) of the present embodiment, for example, the transition metal oxide layer 3 formed of a transition metal oxide containing divalent transition metal ions is formed on the catalyst layer 2. Furthermore, since the positive electric potential is applied to the transition metal oxide layer 3 in the electrolyte aqueous solution in the step (d), the transition metal compound contained in the transition metal oxide layer 3 is further oxidized. As a result, the transition metal compound is converted into a compound which contains trivalent or tetravalent transition metal ions and is selected from the group consisting of a transition metal oxide, a transition metal hydroxide and a transition metal oxyhydroxide. Trivalent transition metal ions are desirable.

In the step (d), if the transition metal oxide contained in the transition metal oxide layer 3 is converted into the transition metal oxyhydroxide, it is desirable that the electrolyte aqueous solution has a pH of not less than 12.

In the step (d), if the stacking structure 4 is immersed in a phosphate buffer solution, the phosphate type ion is coordinated as a ligand around the cobalt oxide. As a result, the cobalt oxide having the phosphate type ion as the ligand therearound functions as the co-catalyst. Hereinafter, in the present specification, such a co-catalyst is referred to as a cobalt oxide phosphate co-catalyst. On this matter, see Non-Patent Literature 2. An example of the phosphate ion is a phosphate ion represented by the chemical formula PO₄³⁻, a hydrogenphosphate ion represented by the chemical formula HPO₄²⁻ or a dihydrogenphosphate ion represented by the chemical formula H₂PO₄⁻.

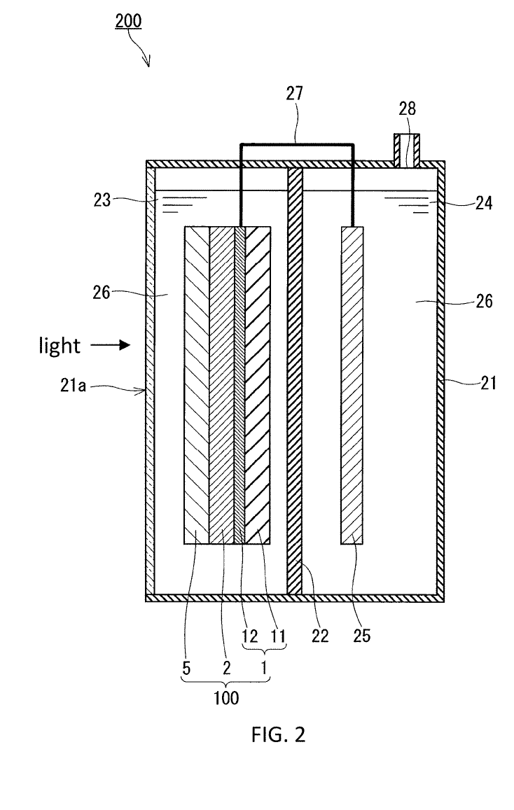

As one example, a Co oxide containing a divalent cobalt ion (e.g., CoO) contained in the transition metal oxide layer 3 is converted into a co-catalyst formed of a Co compound containing a trivalent cobalt ion (e.g., cobalt oxide phosphate, CoO(OH) or Co₃O₄) due to the application of the positive electric potential in the electrolyte aqueous solution. Since the transition metal oxide is insoluble in water, even if the application of the positive electric potential using the potentiostat is continued, or even if light is incident on the stacking structure 4 (See FIG. 2), the transition metal oxide layer 3 is not dissolved in the electrolyte aqueous solution. Therefore, the catalyst layer 2 is not exposed to the electrolyte aqueous solution.

As long as the photocurrent is not prevented from being generated, the catalyst layer 2 may have a thin oxide layer on the surface thereof. The thin oxide layer has a thickness of not more than 10 nanometers. In the inventive example 1 which will be described later, the thin oxide layer formed on the surface of the catalyst layer 2 has a thickness of 6.1 nanometers.

On the other hand, in case where a transition metal layer formed of a transition metal is formed in place of the transition metal oxide layer 3 in the step (b), the positive electric potential is applied to the transition metal layer to oxidize the transition metal contained in the transition metal layer in the step (d). As a result, the transition metal is converted into transition metal ions. Transition metal ions are soluble in water. As a result, it seems that the transition metal layer formed of the transition metal is eroded by water. For this reason, the surface of the catalyst layer 2 is exposed to water. The surface of the catalyst layer 2 exposed to water is oxidized by the continued application of the electric potential with the potentiostat in the step (d). In this way, a thick oxide layer is formed on the surface of the catalyst layer 2. The thick oxide layer may have a thickness more than 10 nanometers. The thick oxide layer formed on the surface of the catalyst layer 2 prevents the photocurrent from being generated. As a result, the efficiency of the photolysis of water is significantly lowered.

(Method for Obtaining Gas with the Electrode 100)

FIG. 2 shows a schematic view of a hydrogen generation device 200 according to the embodiment.

The hydrogen generation device 200 shown in FIG. 2 comprises a housing 21, a separator 22, an electrode 100 according to the embodiment, a counter electrode 25 and an electrolyte solution 26. The separator 22 divides an internal space of the housing 21 into a first space 23 and a second space 24. The electrode 100 is placed in the first space 23. The counter electrode 25 is placed in the second space 24. The electrolyte solution 26 is supplied in the first space 23 and the second space 24.

The electrode 100 is electrically connected to the counter electrode 25 through an electrical joint 27. The hydrogen generation device 200 is provided with a hydrogen gas outlet 28. The hydrogen gas outlet 28 penetrates the housing 21. The hydrogen gas outlet 28 communicates to a space in which hydrogen is generated. In FIG. 2, hydrogen is generated in the second space 24. Although not shown, the hydrogen generation device 200 may be provided with an oxygen gas outlet. The oxygen gas outlet penetrates the housing 21. The oxygen gas outlet communicates to a space in which oxygen is generated. In FIG. 2, oxygen is generated in the first space 23.

The housing 21 comprises a plate-like light-transmissive member 21a which faces the electrode 100. The light passes through the light-transmissive member 21a and is incident on the electrode 100. The light-transmissive member 21a has an insulation property. The light-transmissive member 21a also has corrosion resistance against the electrolyte solution 26. It is desirable that the light-transmissive member 21a is formed of a material through which visible light passes. More preferably, the light-transmissive member 21a is formed of a material through which not only light having a wavelength in a visible light range but also light having a wavelength near the visible light range passes. An example of a material of the light-transmissive member 21a is glass or resin. A part of the housing 21 other than the light-transmissive member 21a has corrosion resistance against the electrolyte solution 26 and an insulation property; however, does not have to be formed of a material through which light passes. An example of the material of the part of the housing 21 other than the light-transmissive member 21a is glass, resin or metal coated with an insulator.

As shown in FIG. 2, it is desirable that the separator 22 is placed substantially parallel to the plate-like light-transmissive member 21a. Ions pass through the separator 22 between the electrolyte solution 26 stored in the first space and the electrolyte solution 26 stored in the second space 24. For this reason, at least a part of the separator 22 is in contact with the electrolyte solution 26 stored in the first space 23 and the electrolyte solution 26 stored in the second space 24. Ions contained in the electrolyte solution 26 pass through the separator 22; however, the separator 22 is formed of a material which prevents an oxygen gas and a hydrogen gas contained in the electrolyte solution 26 from passing through the separator 22. An example of the material of the separator 22 is a solid electrolyte such as a polymer solid electrolyte. An example of the polymer solid electrolyte is an ion exchange membrane such as Nafion (registered trademark). Since the separator 22 divides the space in which oxygen is generated from the space in which hydrogen is generated, oxygen and hydrogen generated in the hydrogen generation device 200 are collected without mixing with each other.

In FIG. 2, the electrode 100 is disposed in such a manner that a front surface of the co-catalyst layer 5 faces the plate-like light-transmissive member 21a. In other words, first, light reaches the front surface of the co-catalyst layer 5, and then, passes through the co-catalyst layer 5 to reach the catalyst layer 2. Alternatively, the electrode 100 may be disposed in such a manner that a back surface of the substrate 1 faces the plate-like light-transmissive member 21a. In other words, light reaches the back surface of the substrate 1, and then, passes through the substrate 1 to reach the catalyst layer 2. In this case, the substrate 1 has to be light-transmissive.

If the co-catalyst contained in the co-catalyst layer 5 absorbs light, the electrode 100 is desirably located in the hydrogen generation device 200 in such a manner that the back surface of the substrate 1 is irradiated with light. Such a location allows the efficiency of water photolysis to be improved.

An example of the material of the counter electrode 25 is carbon, platinum, platinum-supported carbon, palladium, iridium, ruthenium or nickel. The shape of the counter electrode 25 is not limited. The counter electrode 25 may be in contact with an inner wall of the housing 21.

An example of the electrical joint 27 is a typical metal conducting wire.

The electrolyte solution 26 is an aqueous solution in which an electrolyte is dissolved. The electrolyte solution 26 may be acidic, neutral, or basic. An example of the electrolyte is hydrochloric acid, sulfuric acid, nitric acid, potassium chloride, sodium chloride, potassium sulfate, sodium sulfate, sodium hydrogen carbonate, sodium hydroxide, phosphoric acid, sodium dihydrogen phosphate, disodium hydrogen phosphate or sodium phosphate. The electrolyte solution 26 may contain two or more kinds of the electrolytes.

Next, operation of the hydrogen generation device 200 will be described. Since the semiconductor photocatalyst contained in the catalyst layer 2 is an n-type semiconductor, oxygen is generated in the first space 23 including the electrode 100.

Light passes through the light-transmissive member 21a and the electrolyte solution 26 to reach the catalyst layer 2. The catalyst layer 2 absorbs the light. As a result, photoexcitation of electrons occurs. In this way, electrons and holes are generated respectively in a conduction band and a valence band of the catalyst layer 2. The holes migrate from the catalyst layer 2 through the inside of the co-catalyst layer 5 to the front surface of the co-catalyst layer 5 (namely, to the interface between the co-catalyst layer 5 and the electrolyte solution 26). Furthermore, the holes oxidize water molecules on the front surface of the co-catalyst layer 5. As a result, oxygen is generated as shown in the following chemical reaction formula (I) on the front surface of the co-catalyst layer 5.

4h⁺+2H₂O→O₂↑+4H⁺ (I)

where h⁺ is a hole.

On the other hand, the electrons generated in the conduction band of the catalyst layer 2 migrate to the surface of the counter electrode 25 through the conductive film 12 of the substrate 1 and the electrical joint 27. The electrons reduce protons on the surface of the counter electrode 25. As a result, hydrogen is generated as shown in the following chemical reaction formula (II).

4e⁻+4H⁺→2H₂↑ (II)

The hydrogen gas generated in the second space 24 is collected through the hydrogen gas outlet 28.

The co-catalyst contained in the co-catalyst layer 5 promotes a water-splitting reaction. The present inventors do not like to be bound to a theory; however, the present inventors believe that the co-catalyst promotes the water-splitting reaction on the basis of the following theory.

First, the holes are generated through the photoexcitation of the electrons in the catalyst layer 2. Then, the holes migrate to the co-catalyst layer 5. The holes oxidize transition metal ions (e.g., Co³⁺) contained in the co-catalyst layer 5. If the transition metal ions contained in the co-catalyst layer 5 are Co³⁺, Co³⁺ is oxidized by the hole to Co⁴⁺.

Then, water molecules in contact with the co-catalyst layer 5 are oxidized by the transition metal ions (e.g., Co⁴⁺) generated due to the oxidation by the holes. In this way, oxygen is generated, and the transition metal ions are reduced. If the transition metal ions generated due to the oxidation by the holes are Co⁴⁺, Co⁴⁺ is reduced by a water molecule to Co²⁺.

The holes oxidize the transition metal ions (e.g., Co²⁺) contained in the co-catalyst layer 5. If the transition metal ions generated due to the reduction by the water molecule are Co²⁺, Co²⁺ is oxidized by the hole to Co³⁺.

As just described, a cycle of the oxidation and the reduction of the cobalt ions is repeated in the order of Co³⁺, Co⁴⁺, Co²⁺, and Co³⁺. The transition metal ions contained in the co-catalyst layer 5 serve as the co-catalyst on the basis of the repetition.

### EXAMPLES

The present invention will be described in more detail with reference to the following examples.

### Inventive Example 1

In the inventive example 1, a substrate 1 was prepared. As shown in FIG. 1A, the substrate 1 comprised an insulation substrate 11 formed of sapphire and a conductive film 12 formed of tin oxide doped with antimony on the insulation substrate 11. The substrate 1 had an area of approximately 1 cm².

As shown in FIG. 1B, while the substrate 1 was heated at 650 degrees Celsius, an NbON film as a catalyst layer 2 was formed by a reactive sputtering method on the substrate 1. The sputtering was conducted in a gaseous mixture atmosphere containing oxygen and nitrogen. The gaseous mixture had a volume ratio of O₂:N₂=1:20. The sputtering target was formed of a niobium nitride represented by the composition formula NbN.

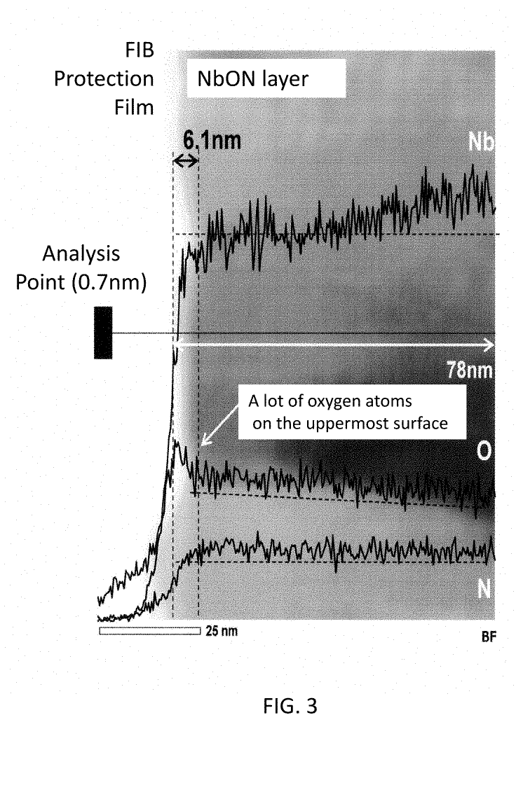

FIG. 3 is a scanning transmission electron microscope (hereinafter, referred to as “STEM”) image of a surface of a catalyst layer 2 formed of NbON in the inventive example 1. In FIG. 3, an element composition analysis result based on the STEM image is also shown. As shown in FIG. 3, the catalyst layer 2 formed of NbON had an oxide layer (more exactly, a layer containing a lot of oxygen) having a thickness of approximately 6.1 nanometers on the surface thereof. Then, as shown in FIG. 1C, a transition metal oxide layer 3 composed of a Co oxide was formed by an arc plasma vapor deposition method as below on the surface of the catalyst layer 2 formed of NbON.

First, the substrate 1 having the catalyst layer 2 (See FIG. 1B) was loaded onto a stage in an arc plasma vapor deposition device. An argon gas (purchased from Taiyo Nippon Sanso Corporation, degree of purity: over 99.999%) was supplied to the inside of the arc plasma vapor deposition device in such a manner that the inside of the device had an argon atmosphere having a pressure of 6×10⁰ Pa. The present inventors believed that the argon gas contained an oxidized gas (e.g., O₂ or H₂O) as impurities at a concentration of not more than 0.001 volume %. Therefore, the present inventors believed that the oxidized gas included in the device had a partial pressure of not more than 6×10⁻⁵ Pa during the formation of the transition metal oxide layer 3. Then, a cobalt compound was deposited by an arc plasma method on the catalyst layer 2 formed of NbON under the following conditions. In this way, the transition metal oxide layer 3 formed of a Co oxide was formed on the catalyst layer 2.

Vapor deposition source: Co metal

Arc plasma vapor deposition voltage: 100 volts

Capacitance of capacitor: 1,080 μF

Vapor deposition frequency: 3 Hz (i.e., three times per second)

Number of times of vapor deposition: 500 times

The valence of the cobalt cation included in the deposited cobalt compound was identified in accordance with the method disclosed in Non-Patent Literature 5.

According to Non-Patent Literature 5, especially in FIG. 3, Co²⁺ has a peak at 787 eV in an X-ray photoelectron spectroscopy. On the other hand, Co³⁺ does not have a peak at 787 eV. A metal Co does not have a peak at 787 eV, either.

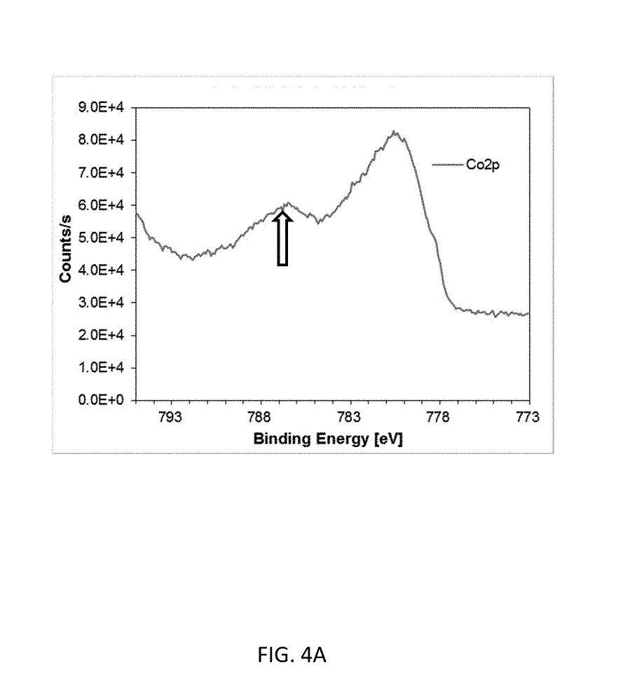

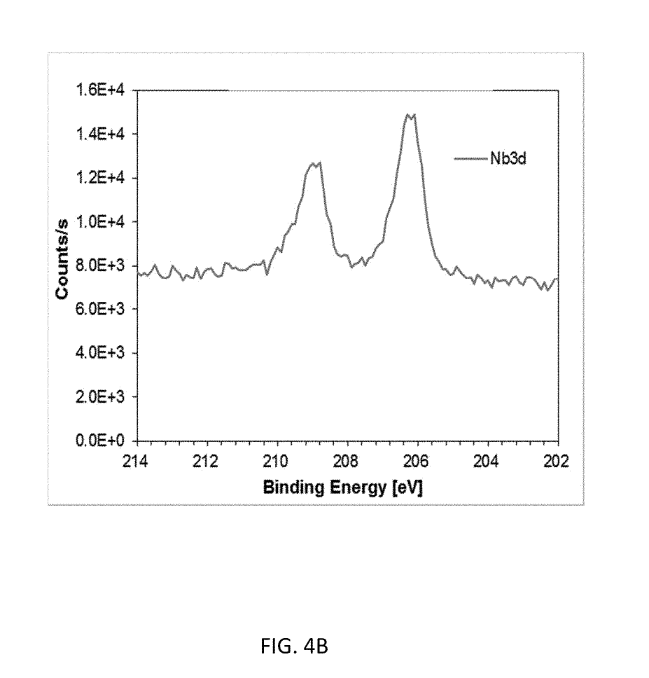

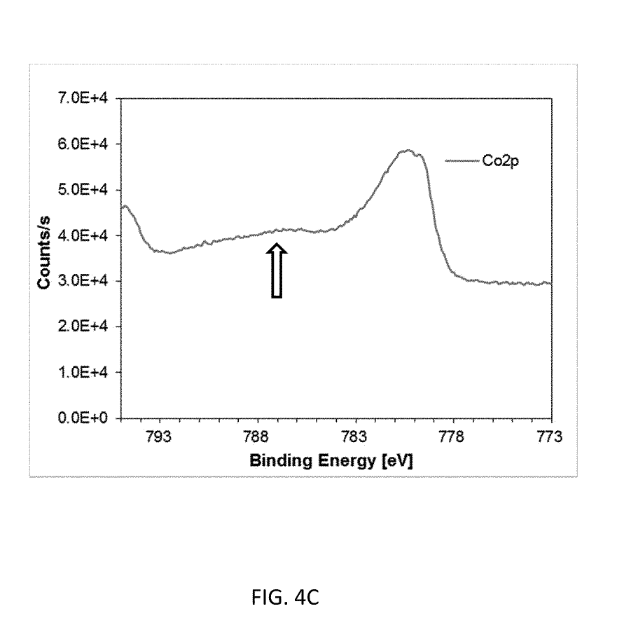

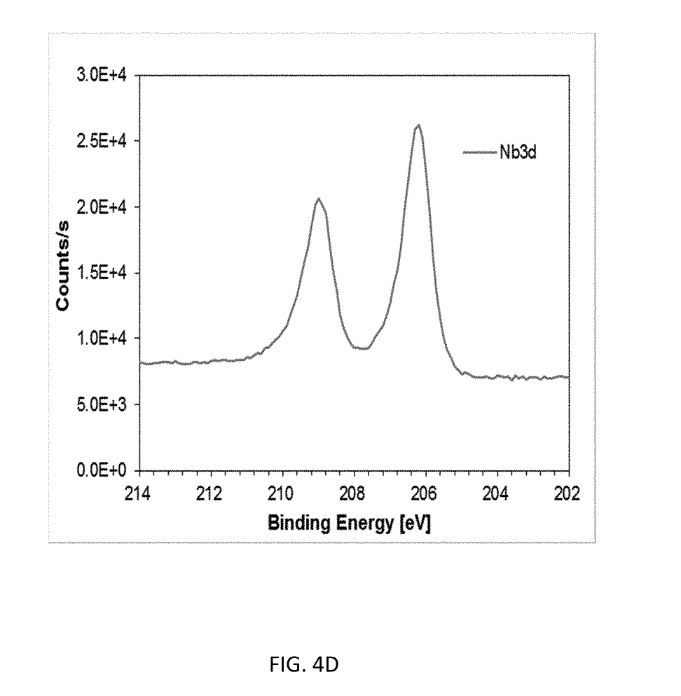

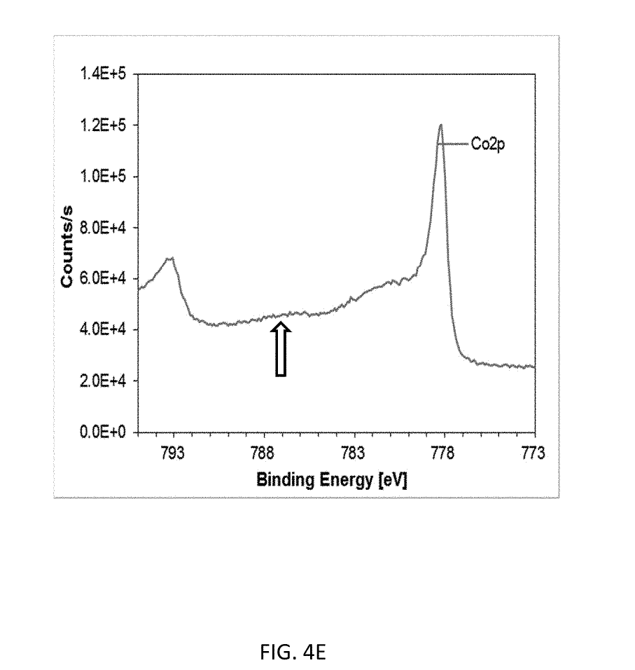

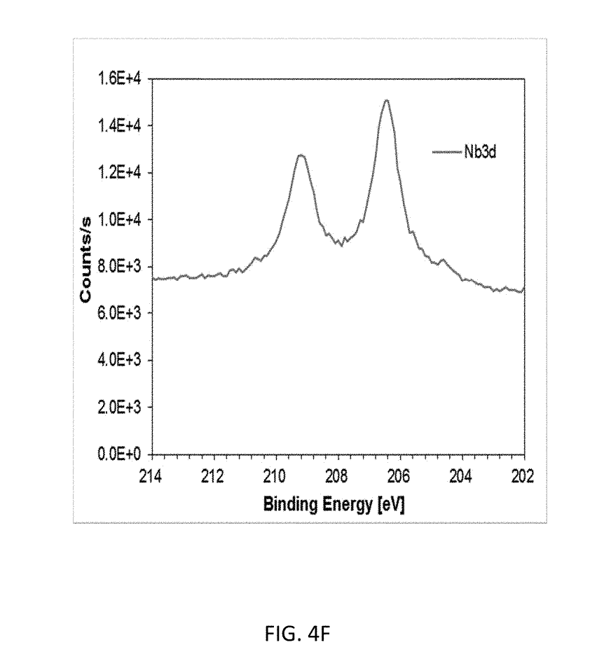

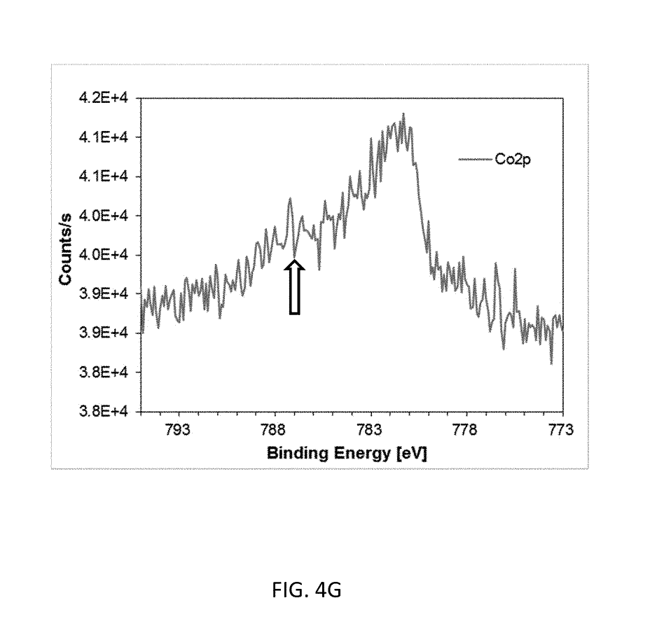

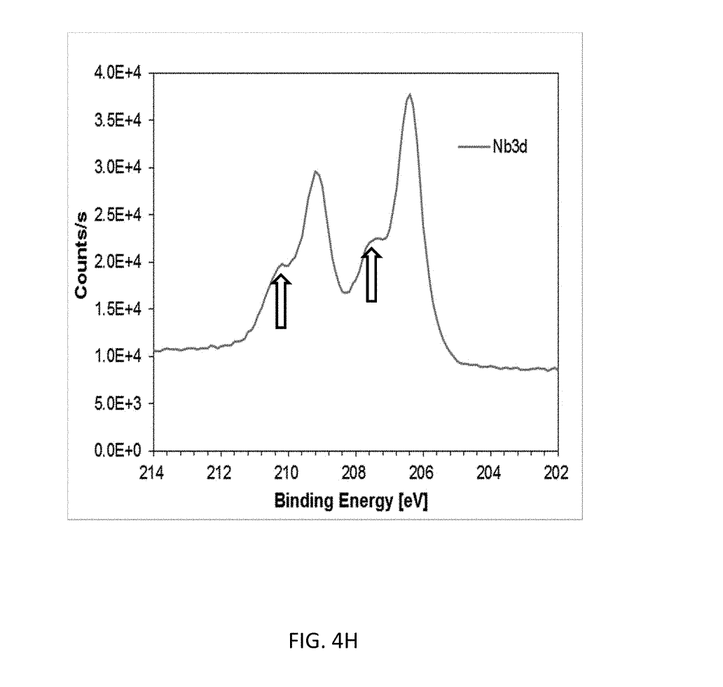

The deposited Co compound was analyzed on the basis of a Hard X-ray photoemission spectroscopy (hereinafter, referred to as “HAXPES”) with a SPring-8 BL16XU beam line. FIG. 4A shows an HAXPES analysis result of the transition metal oxide layer 3 formed of the Co oxide at this stage in the inventive example 1. In other words, FIG. 4A shows an HAXPES analysis result of the transition metal oxide layer 3 in the inventive example 1 before a positive electric potential was applied to the substrate 1. As indicated by the arrow included in FIG. 4A, since a peak at 787 eV appeared in FIG. 4A, the transition metal oxide layer 3 formed of the Co oxide contained Co²⁺.

Similarly, the Nb compound in the catalyst layer 2 was also analyzed on the basis of the HAXPES. FIG. 4B shows an HAXPES analysis result of the catalyst layer 2 formed of the niobium oxynitride represented by the chemical formula NbON at this stage in the inventive example 1.

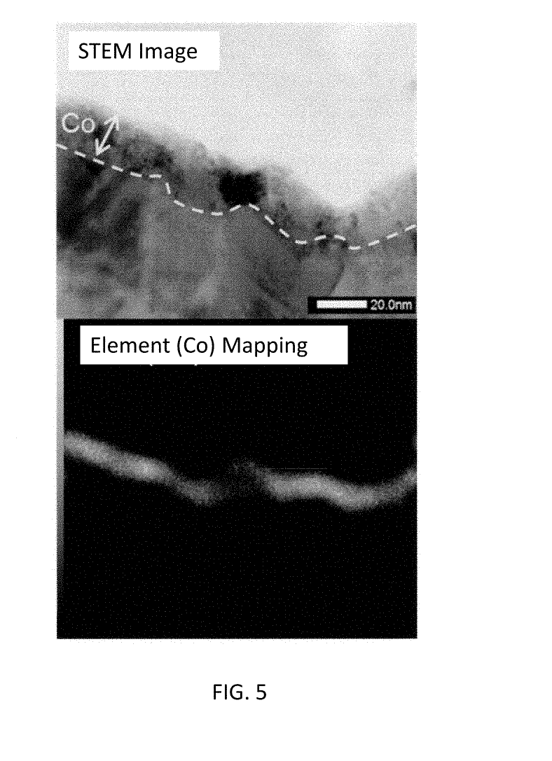

FIG. 5 is STEM image of the substrate 1 having the transition metal oxide layer 3 (See FIG. 10). In FIG. 5, the transition metal oxide layer 3 having a thickness of approximately 20 nanometers covers the surface of the catalyst layer 2 densely.

Then, the substrate 1 having the transition metal oxide layer 3 (See FIG. 10) was immersed in a mixture buffer solution (100 mL, pH: 7) of sodium dihydrogen phosphate (i.e., NaH₂PO₄)-disodium hydrogen phosphate (i.e., Na₂HPO₄) in a light-transmissive glass beaker. A counter electrode formed of Pt and an Ag/AgCl reference electrode were also immersed in the mixture buffer solution. The substrate 1 as a working electrode, the counter electrode, and the reference electrode were electrically connected to a potentiostat. While the transition metal oxide layer 3 was irradiated with light emitted by a xenon light source (wavelength: over 420 nanometers), an electric potential of +1.1 volts (vs. RHE) was applied to the substrate 1 for 30 minutes in the mixture buffer solution. In this way, the transition metal oxide layer 3 was converted into a co-catalyst layer 5 to provide an electrode 100. In the inventive example 1, the photovoltaic power generated due to the irradiation of the catalyst layer 2 formed of NbON with light was spent as a part of the positive electric potential applied to the substrate 1 to convert the transition metal oxide layer 3 into the co-catalyst layer 5.

Then, a photoelectrochemical property of the electrode 100 was measured by the following method. A mixture buffer solution (100 mL, pH: 8) of sodium dihydrogen phosphate (i.e., NaH₂PO₄)-disodium hydrogen phosphate (i.e., Na₂HPO₄) was supplied to a light-transmissive glass beaker. The electrode 100 was immersed in the mixture buffer solution together with the counter electrode formed of Pt and the Ag/AgCI reference electrode. The substrate 1, the counter electrode and the reference electrode were electrically connected to the potentiostat. An electric potential of +1.1 volts (vs. RHE) was applied to the electrode 100 and the electrode 100 was irradiated with visible light using the xenon light source (wavelength: over 420 nanometers). The co-catalyst layer 5 was made to face a plate-like light-transmissive member 21a, and the co-catalyst layer 5 was irradiated with the visible light. The current density of the obtained photocurrent was measured. Furthermore, the electrode 100 was analyzed by a HAXPES.

The valence of the cobalt cation included in the Co compound included in the co-catalyst layer 5 was identified in accordance with the method disclosed in Non-Patent Literature 5. FIG. 4C shows an HAXPES analysis result of the co-catalyst layer 5 formed of the Co oxide at this stage in the inventive example 1. In other words, FIG. 4C shows an HAXPES analysis result of the transition metal oxide layer 3 in the inventive example 1 after the positive electric potential was applied to the substrate 1. As indicated by the arrow included in FIG. 4C, a peak at 787 eV disappeared in FIG. 4C. Since the cobalt oxide was further oxidized due to the application of the electric potential, the transition metal oxide layer 3 formed of the Co oxide contained Co³⁺.

FIG. 4D shows an HAXPES analysis result of the catalyst layer 2 formed of the niobium compound at this stage in the inventive example 1. In other words, FIG. 4D shows an HAXPES analysis result of the catalyst layer 2 in the inventive example 1 after the positive electric potential was applied to the substrate 1. As is clear from the comparison of FIG. 4B with FIG. 4D, in the inventive example 1, the Nb compound of the catalyst layer 2 did not change. Therefore, the present inventors believe that the catalyst layer 2 contained NbON even after the positive electric potential was applied to the substrate 1.

### Comparative Example 1

In the comparative example 1, an experiment similar to the inventive example 1 was conducted except that the arc plasma vapor deposition was conducted in a vacuum (pressure: 1.5×10⁻³ Pa). In other words, in the comparative example 1, the argon gas was not supplied into the arc plasma vapor deposition device. FIG. 4E and FIG. 4G show HAXPES analysis results of the transition metal oxide layer 3 in the comparative example 1, before and after the positive electric potential was applied to the substrate 1, respectively. As indicated by the arrow included in FIG. 4E, since a peak at 787 eV did not appear, the transition metal oxide layer 3 formed of the Co oxide did not contain Co²⁺. Since the arc plasma vapor deposition was conducted in a vacuum, the transition metal oxide layer 3 was formed of metal Co.

FIG. 4F and FIG. 4H show HAXPES analysis results of the catalyst layer 2 in the comparative example 1, before and after the positive electric potential was applied to the substrate 1, respectively. In FIG. 4F, two peaks appear. On the other hand, in FIG. 4H, as indicated by the two arrows, additional two peaks appear. The positions of the additional two peaks correspond to Nb₂O₅. As is clear from the comparison of FIG. 4F with FIG. 4H, in the comparative example 1, the Nb compound of the catalyst layer 2 changed after the positive electric potential was applied to the substrate 1. The present inventors believe that the Nb compound was converted into Nb₂O₅ at the surface of the catalyst layer 2 due to the application of the positive electric potential to the substrate 1 in the comparative example 1.

### Comparative Example 2

In the comparative example 2, an experiment similar to the inventive example 1 was conducted except that the arc plasma vapor deposition was not conducted. In other words, in the comparative example 2, neither the transition metal oxide layer 3 nor a transition metal layer was formed. Therefore, the electrode 100 according to the comparative example 2 had the catalyst layer 2 formed of NbON on the surface thereof.

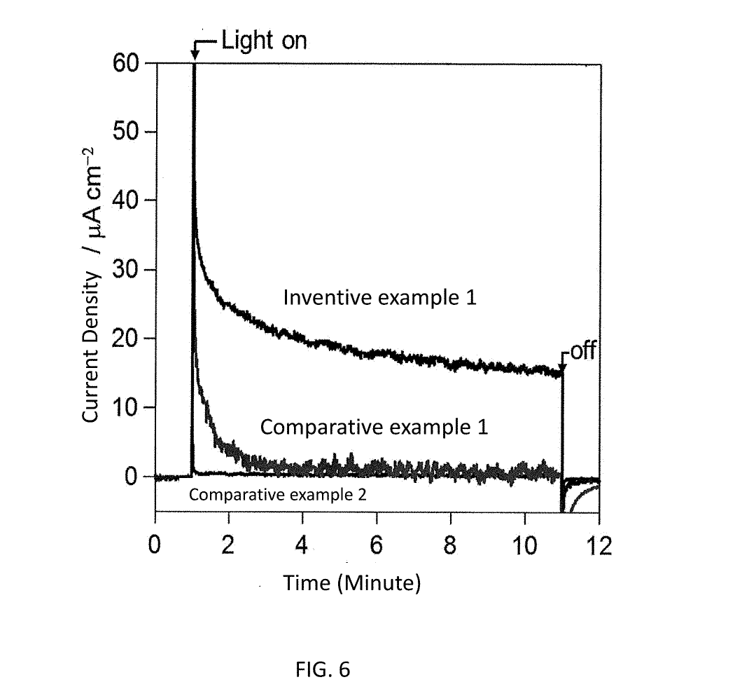

FIG. 6 shows the results of the photocurrent measurement of the electrodes 100 according to the inventive example 1, the comparative example 1, and the comparative example 2. In other words, FIG. 6 is a graph showing a relation between a current density of a photocurrent of an electrode 100 and a time in the inventive example 1, the comparative example 1, and the comparative example 2.

As is clear from FIG. 6, in the comparative example 2, no photocurrent was observed. Also in the comparative example 1, a photocurrent was seldom observed. On the other hand, in the inventive example 1, a photocurrent of approximately 20 μA/cm² was observed. As just described, water is split with light efficiently using the electrode comprising the transition metal oxide layer 3 formed by the arc plasma vapor deposition method in the inert gas atmosphere containing the oxidized gas as impurities. On the other hand, water is not split with light efficiently when using the electrode comprising the transition metal layer formed by the arc plasma vapor deposition method in the vacuum atmosphere which does not contain the oxidized gas as impurities.

As is clear from the HAXPES analysis results shown in FIG. 4B, FIG. 4D, FIG. 4F and FIG. 4H, in the inventive example 1, the surface of the catalyst layer 2 formed of NbON was prevented from being oxidized by the transition metal oxide layer 3 formed by the arc plasma vapor deposition method in the inert gas atmosphere containing the oxidized gas as impurities. On the other hand, in the comparative example 1, the transition metal layer formed by the arc plasma vapor deposition method in the vacuum atmosphere failed to prevent the surface of the catalyst layer 2 formed of NbON from being oxidized.

Since the arc plasma vapor deposition was conducted in the inert gas atmosphere containing the oxidized gas as impurities in the inventive example 1, the transition metal oxide layer 3 composed of a cobalt oxide (probably, CoO) was formed on the catalyst layer 2 composed of NbON. Due to the application of the positive electric potential with the potentiostat to the transition metal oxide layer 3 composed of the cobalt oxide, the transition metal oxide layer 3 is converted into cobalt oxide phosphate, Co₃O₄ or cobalt oxyhydroxide. Since a cobalt oxide phosphate, cobalt oxide and cobalt oxyhydroxide are insoluble in water, they are not dissolved in water, even if the application of the electric potential with the potentiostat is continued, or even if light is incident thereon in water (See FIG. 2). Therefore, the catalyst layer 2 covered with such a transition metal oxide layer 3 is not exposed to water. For this reason, water is split efficiently with light.

In the comparative example 1, since the arc plasma vapor deposition was conducted in a vacuum, the transition metal layer composed of metal Co was formed on the catalyst layer 2 composed of NbON. Due to the application of the positive electric potential with the potentiostat to the transition metal layer composed of metal cobalt, the transition metal layer is oxidized. For this reason, the metal cobalt is converted into Co²⁺ to dissolve in water. In this way, the surface of the catalyst layer 2 formed of NbON is exposed to water. Due to continuation of the application of the electric potential with the potentiostat, the surface of the catalyst layer 2 which has been exposed to water is oxidized. For this reason, in the comparative example 1, a thick oxide layer is formed on the surface of the catalyst layer 2. The thick oxide layer formed on the surface of the catalyst layer 2 in this way prevents the photocurrent from being generated. As a result, the efficiency of the photolysis of water is significantly lowered.

### INDUSTRIAL APPLICABILITY

The electrode for water splitting according to the present invention can be used to generate hydrogen through water splitting by irradiation with light such as sunlight. The generated hydrogen can be supplied to a fuel cell.

### REFERENTIAL SIGNS LIST

1 Substrate
2 Catalyst layer
3 Transition metal oxide layer
4 Stacking structure
5 Co-catalyst layer
11 Insulation substrate
12 Conductive film
21 Housing
21a Light-transmissive member
22 Separator
23 First space
24 Second space
25 Counter electrode
26 Electrolyte solution
27 Electrical joint
28 Hydrogen gas outlet

1. A method for fabricating an electrode comprising a co-catalyst layer for splitting water with light, the method comprising:
(a) forming a catalyst layer containing at least one selected from the group consisting of a niobium-containing oxynitride and a niobium-containing nitride on an electrically conductive principal surface of a substrate;
(b) forming a transition metal oxide layer on the catalyst layer in an inert gas atmosphere containing oxidized gas impurities to provide a stacking structure comprising the substrate, the catalyst layer, and the transition metal oxide layer;
(c) immersing the stacking structure in an electrolyte aqueous solution; and
(d) applying a positive electric potential to the stacking structure in the electrolyte aqueous solution to convert the transition metal oxide layer into the co-catalyst layer.

2. The method according to claim 1, wherein
the inert gas is argon.

3. The method according to claim 1, wherein
the inert gas has a partial pressure of not less than 10⁻¹ Pa and not more than 10² Pa.

4. The method according to claim 1, wherein
the oxidized gas impurities are at least one selected from the group consisting of oxygen and water.

5. The method according to claim 1, wherein
the oxidized gas impurities have a partial pressure of not less than 10⁻⁵ Pa and not more than 10° Pa.

6. The method according to claim 1, wherein
the electrolyte aqueous solution contains at least one selected from the group consisting of hydrogen phosphate ions and dihydrogen phosphate ions.

7. The method according to claim 1, wherein
the electrolyte aqueous solution has a pH of not less than 12.

8. The method according to claim 1, wherein
the niobium-containing oxynitride is a niobium oxynitride represented by the chemical formula NbON; and
the niobium-containing nitride is a niobium nitride represented by the chemical formula Nb₃N₅.

9. The method according to claim 1, wherein
the transition metal oxide layer contains divalent metal ions; and
the co-catalyst layer contains trivalent metal ions.

10. The method according to claim 1, wherein
a transition metal contained in the transition metal oxide layer is cobalt.

11. The method according to claim 10, wherein
the transition metal oxide layer contains divalent cobalt ions; and
the co-catalyst layer contains trivalent cobalt ions.

12. An electrode for water splitting, comprising:
a substrate having an electrically conducive principal surface;
a catalyst layer formed on the electrically conducive principal surface and containing at least one selected from the group consisting of a niobium-containing oxynitride and a niobium-containing nitride; and
a co-catalyst layer covering the catalyst layer;
wherein
the co-catalyst layer contains a co-catalyst for promoting a water-splitting reaction caused by light;
the co-catalyst contains a transition metal oxide; and
the transition metal oxide contains trivalent or tetravalent transition metal ions.

13. The electrode for water splitting according to claim 12, wherein
the niobium-containing oxynitride is a niobium oxynitride represented by the chemical formula NbON; and
the niobium-containing nitride is a niobium nitride represented by the chemical formula Nb₃N₅.

14. The electrode for water splitting according to claim 12, wherein
the co-catalyst contains trivalent transition metal ions.

15. The electrode for water splitting according to claim 14, wherein
the trivalent transition metal ions are trivalent cobalt ions.

16. The electrode for water splitting according to claim 12, wherein
the co-catalyst further contains at least one selected from the group consisting of hydrogen phosphate ions and dihydrogen phosphate ions.

17. The electrode for water splitting according to claim 12, wherein
the co-catalyst contains at least one selected from the group consisting of Co₃O₄ and cobalt oxyhydroxide.
